(19) United States
(12) Patent Application Publication
(10) Pub. No.: US 2023/0045953 A1
(43) Pub. Date: Feb. 16, 2023

(54) Phone case

(71) Applicant: Rong YAN, Shenzhen (CN)

(72) Inventor: Rong YAN, Shenzhen (CN)

(21) Appl. No.: 17/403,868

(22) Filed: Aug. 16, 2021

(51) Int. Cl. H04B 1/3888; A45C 11/00; A45C 13/00; A45C 13/36

(52) U.S. Cl. CPC H04B 1/3888; A45C 11/00; A45C 13/001; A45C 13/36; A45C 2011/002

(57) ABSTRACT

This patent provides a phone case. The backplate and side plate constitute the accommodating cavity of phone, and it is the amplifying cavity; Reinforcing rib is equipped at the edge of back plate. It may protrude to the inside and butt against the mobile phone frame. When the phone falls, the reinforcing rib or side plate separates the phone screen or phone body from the ground, cushions the impact of the ground and transfers the impact force to the phone frame, to avoid that the impact force directly acts on the phone screen and body. It has the great anti-falling effect.

### BACKGROUND OF THE INVENTION

This utility model involves the field of phone protection, especially, phone case.

In the present society, mobile phones have been more and more applied, they have become necessary electric devices for life, work and entertainment. The structure of mobile phone includes frame, screen on the reverse side and rear cover on the obverse side. Inside, there are extensive and precise electronic components, wherein, the screen and the electronic components are with relatively poor anti-seismic and drop resistance performance. In daily life, the phones are protected by wearing of phone case. However, the phone cases where the existing technologies are used cannot sufficiently protect the phone screen, and when the phone falls down, if the screen is downwards, it will be damaged.

### BRIEF SUMMARY OF THE INVENTION

To overcome the insufficiency of the existing technologies, one of the purposes of this utility model is to provide a phone case to solve the technical problems of the phone case where the existing technologies are applied, i.e., insufficient protection to phone screen.

One of the purposes of this utility model is achieved by the following technical scheme:

A phone case, including back plate and side panels. The mentioned side panels are set along the four edges of the back plate, and the side panels are connected in a head-to-tail manner. The mentioned back plate and side panels enclose to form an accommodating cavity to accommodate phone;

The mentioned edges of the mentioned side panels which are far from the back plate are equipped with reinforcing bars. The mentioned reinforcing bars bulge to the inside to resist to the phone frame.

Optionally, the cross section of the mentioned side panels is arc-shaped. There is a buffer gap between the inner lateral face of the mentioned side panels and phone frame; Or,

The cross section outline of the mentioned side panels includes the first segmental arc, the second segmental arc and the central segment between the mentioned first segmental arc and second segmental arc. There is a buffer gap between the inner lateral face of the mentioned side panels and phone frame.

Optionally, the inner lateral face of the mentioned back plate is set with several supports, the mentioned supports support the mentioned back plate to form a cavity with the reverse side of the phone.

Optionally, the mentioned side panels are equipped with tune tropes corresponding to the sounding positions of the phone. There are acoustic links between the mentioned tune tropes and the mentioned cavity. One end of the mentioned acoustic links connect to the mentioned tune trope, and other end connects to the mentioned cavity.

Optionally, the two sides of the mentioned back plate are equipped with shrinking area.

Optionally, the upper end and lower end of the reverse side of the mentioned back plate are set with cambered surface or slope.

Optionally, the reverse side of the mentioned back plate is equipped with phone support.

Optionally, the mentioned phone support includes fixed seat, rotating disk and ring. The mentioned fixed seat is fixed on the mentioned back plate. The mentioned rotating disk can be set on the mentioned fixed seat in a rotating way. The mentioned ring is hinged to the mentioned rotating disk.

Optionally, the edge of the mentioned rotating disk is equipped with the part for hinge joint. The shape of the inner ring of the mentioned ring matches with the shape of the mentioned rotating disk. The mentioned ring has an open mouth. The mentioned ring forms two hinged ends on the two sides of the mentioned open mouth. The two mentioned hinged ends are located at the two sides of the mentioned part for hinge joint, and the two hinged ends are hinged to the mentioned part for hinge joint.

Optionally, the mentioned rotating disk is a magnetic rotating disk; Or,

There is a magnet set in the mentioned rotating disk; Or,

The mentioned fixed seat is a magnetic fixed seat; Or,

There is a magnet set in the mentioned fixed seat.

Compared with the existing technologies, the utility model has the following beneficial effects: The edges of the side panels which are far from the back plate are equipped with reinforcing bars. The reinforcing bars bulge in the inside, which means, the reinforcing bars bulge in the accommodating cavity. When the phone wears the phone case, the reinforcing bars resist to phone frame. When the obverse side of the phone is placed on the table top downwards, the reinforcing bars can isolate the phone screen from the table top to prevent the phone screen touching the table top. Therefore, this phone case has good effects to prevent screen scratch; Meanwhile, when the obverse side of the phone falls to the ground, similarly, the reinforcing bars can isolate the phone screen from the ground, the reinforcing bars will touch the ground firstly, so that the impact the ground will be relieved, and the remaining impulsive force of the ground will be transferred to phone frame. By this way, the direct effect of impulsive force on phone screen can be avoid, leading to good protection of screen.

### BRIEF DESCRIPTION OF THE DRAWINGS

FIG. 1 is the schematic diagram for the structure on the obverse side of the phone case of this utility model;

FIG. 2 is the schematic diagram for the stereochemical structure on the obverse side of the phone case of this utility model;

FIG. 3 is the schematic diagram for the structure on the reverse side of the phone case of this utility model;

FIG. 4 is the schematic diagram for the structure on the lateral side of the phone case of this utility model;

FIG. 5 is the diagrammatic cross-section of the phone case of this utility model wore on phone;

FIG. 6 is the enlarged view of local area A in FIG. 5.

### IN THE FIGURE

1. Back plate; 11. Support; 12. Camera hole; 13. Shrinking area; 14. Cambered surface; 15. Acoustic link; 1a. Cavity;

2. Side panel; 21. Upper side plate; 22. Lower side plate; 23. Left plate; 24. Right plate; 25. Reinforcing bar; 251. Resisting face; 26. Tune trope; 2a. Buffer gap;

3. Phone support; 31. Fixed seat; 32. Rotating disk; 321. Part for hinge joint; 33. Ring; 331. Hinged end.

### DETAILED DESCRIPTION OF THE INVENTION

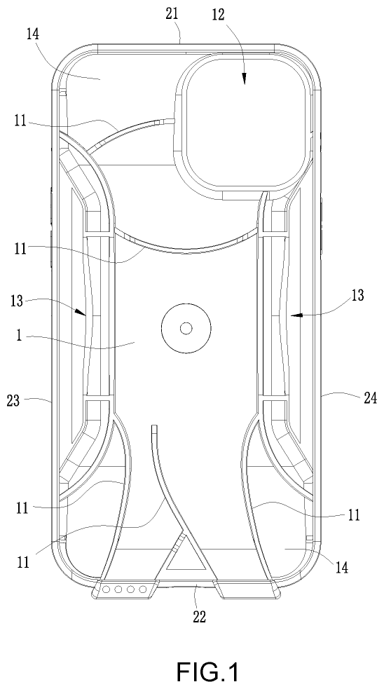

Next, this utility model is further described combining with the attached FIGS. 1-10 and specific implementation modalities. What needs to be explained is that, on the premise of no conflict, arbitrary combination of the examples and technical feature described below can form new examples.

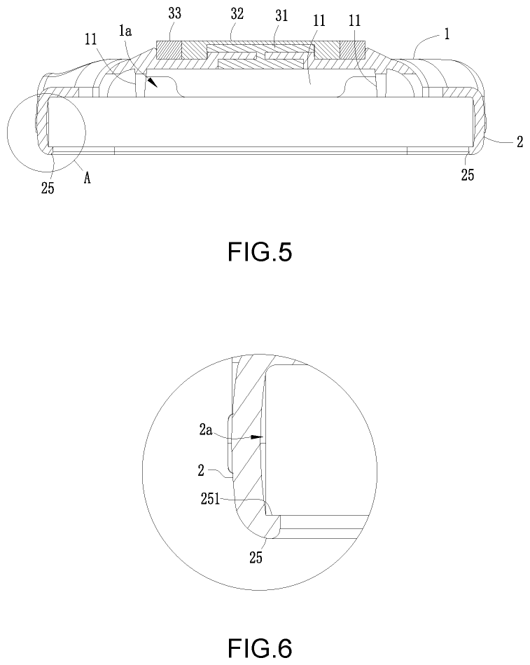

As shown in FIG. 1, FIG. 5 and FIG. 6, this utility model provides a phone case, including back plate 1 and side panels 2. Side panels 2 are set along the four edges of back plate 1, and side panels 2 are connected in a head-to-tail manner to form the frame to protect the phone. The back plate 1 and side panels 2 enclose to form an accommodating cavity to accommodate phone. Back plate 1 protects the reverse side of phone, side panels 2 protect the frame and four angles of phone, so that multidirectional protection can be formed for phone. In this example, the edges of the side panels 2 which are far from the back plate 1 are equipped with reinforcing bars 25. The reinforcing bars 25 bulge to the inside (in this utility model, inside means the side pointing to the accommodating cavity) to resist to the phone frame, which means, the reinforcing bars 25 bulge in the accommodating cavity. When the phone wears the phone case, the reinforcing bars 25 resist to phone frame. When the obverse side of the phone is placed on the table top downwards, the reinforcing bars 25 can isolate the phone screen from the table top to prevent the phone screen touching the table top. Therefore, this phone case has good effects to prevent screen scratch; Meanwhile, when the obverse side of the phone falls to the ground, similarly, the reinforcing bars 25 can isolate the phone screen from the ground, the reinforcing bars 25 will touch the ground firstly, so that the impact the ground will be relieved, and the remaining impulsive force of the ground will be transferred to phone frame. By this way, the direct effect of impulsive force on phone screen can be avoid, leading to good protection of screen.

For some examples, as shown in FIG. 6, reinforcing bars 25 form a resisting face to back plate 1. When the phone wears the phone case, the resisting face 251 resists phone frame. By setting this resisting face 251, the reinforcing bars 25 can well match with phone frame. Especially, when the reinforcing bars 25 are impacted, it can be ensured that the reinforcing bars 25 well fit with phone frame, so that it can be avoided that the reinforcing bars 25 slip out after being impacted, leading to exposed phone screen.

For some examples, as shown in FIG. 1, side panels 2 include upper side plate 21, lower side plate, left plate 23 and right plate 24. Upper side plate 21, left plate 23, lower side plate 22 and right plate 24 connect successively in a head-to-tail manner to form the frame to protect the phone.

For some examples, as shown in FIG. 5 and FIG. 6, the cross section of side panels 2 is arc-shaped. There is buffer gap 2a between the inner lateral face 2 of the side panels and phone frame; Buffer gap 2a, in other words, the relief chamber. In this example, cross section of side panels 2 is arc-shaped. There is buffer gap 2a between side panels 2 and phone frame. When the lateral face or one angle of the phone falls to the ground, side panels 2 touch the ground first, by buffer gap 2a, the impact of the ground is buffered, which greatly improve the protective effects of the phone case on four edges and four angles of the phone.

For other examples with above mentioned buffer gap 2a, the cross sectional outline of the side panels 2 includes the first segmental arc (not indicated in the figure), the second segmental arc (not indicated in the figure) and the central segment (not indicated in the figure) between the mentioned first segmental arc and second segmental arc. There is buffer gap 2a between the inner lateral face of side panels 2 and phone frame.

For buffer gap 2a of this example, it has complete segmental arc or part segmental arc, depending on the cross section of side panels 2, which leads to buffer gap 2a or relief chamber formed between side panels 2 and phone frame. When the lateral face of phone frame is straight or tends to be straight, larger buffer gap 2a or relief chamber can be formed by phone frame and side panels 2. The phone case in this example is more applicable to the phone whose frame is straight or tends to be straight.

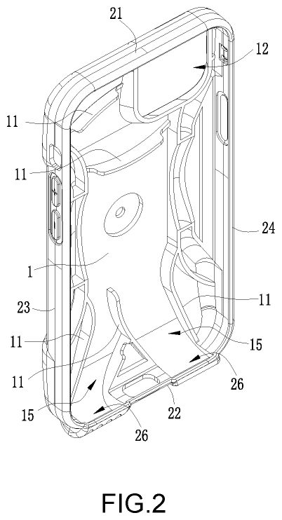

For some examples, as shown in FIG. 1 and FIG. 2, the inner lateral face of the back plate 1 is set with several supports 11, the supports 11 support back plate 1 to form a cavity 1a with the reverse side of the phone. When the phone wears phone case and the phone falls down with the reverse side touching the ground, back plate 1 of the phone case will touch the ground firstly, and the above mentioned cavity 1a can relief the impact of the ground.

In addition, supports 11 are reinforcement plate. On one hand, they can increase the strength of back plate 1; On other hand, when the phone case undergoes concentrated external point impact, back plate 1 can transfer impulsive force by supports 11, and supports 11 decentralize the impulsive force from back plate 1 to the reverse side of the phone to make local pressure decentralized to avoid that the external impulsive force separately impacts the reverse side of the phone, so that, the protective effects of the phone case on the reverse side can be further improved.

To sum up, the above mentioned reinforcing bars 25 and side panels 2 which form buffer gap 2a with phone frame provide all-round and enhanced protection to the obverse side, reverse side, four edges and four angles in this example, so as to improve all-round protective effects of the phone case on the phone wholly.

For some further examples, as shown in FIG. 1, back plate 1 is set with camera hole 12 corresponding to the camera of phone. When the phone wears phone case, the camera on the reverse side of the phone exactly faces camera hole 12. There is cavity 1a between back plate 1 and reverse side of the phone, therefore, there is a certain distance between back plate 1 and the reverse side of the phone. For some phones, when the phones where the phone case, even the cameras are higher than the reverse side of the phones, the cameras can be completed accommodated by camera hole 12, and they will not be higher than back plate 1, so that, when the phone is placed on the table top with its reverse side down, the cameras will not be scratched, thus, the cameras can be well protected.

For some further examples, as shown in FIG. 1 and FIG. 2, side panels 2 are equipped with tune tropes 26 corresponding to the sounding positions of the phone. There are acoustic links 15 between tune tropes 26 and cavity 1a. One end of acoustic links 15 connect to tune trope 26, and other end connects to cavity 1a. When the phone sounds, the sound is transferred to tune trope 26, and transferred to cavity 1a by acoustic links 15 to be amplified in cavity 1a.

Specifically, the inner lateral face of back plate 1 is equipped with supports 11 which have the function of leading tone on both sides of acoustic links 15.

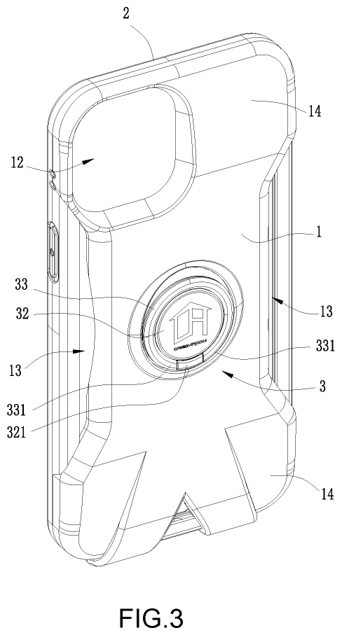

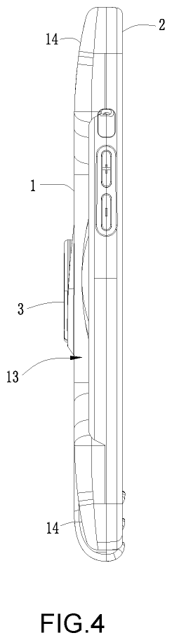

For some examples, as shown in FIG. 3 and FIG. 4, the two sides of back plate 1 are equipped with shrinking area 13. In this example, cavity 1a is formed between back plate 1 and reverse side of phone, relatively, the thickness of phone case is increased, therefore, shrinking area 13 is set at both end of back plate 1 in the example to shorten the waist length of this phone case. When the center of the phone is held, the holding length required by hands is shortened, making the users have thinner holding feeling.

For some further examples, as shown in FIG. 3 and FIG. 4, the upper end of the reverse side of back plate 1 is set with cambered surface 14 or slope, the lower end of the reverse side of back plate 1 is set with cambered surface 14 or slope. In the area where the above mentioned cambered surface 14 or slope locates, the closer to the side panel 2 at the upper end or lower end of back plate 1, the smaller the thickness of the phone case is, so that the peripheral length of the upper end and lower end of the phone case is reduced, the holding length required by hands is shortened, leading to thinner holding feeling to the upper end and lower end of the phone case. When the phone is in landscape, better holding experience can be obtained for gaming.

Comprehensively, the integral shape of the phone case is beautiful, complying with body structure. The peripheral length of multiple holding parts is relatively short, and holding is comfortable. The phone case will not leave the feeling of being thick to users.

For some examples, as shown in FIG. 3 and FIG. 4, the reverse side of back plate 1 are equipped with phone support 3. In this example, by setting phone support 3, the phone can be leanly supported in landscape. When the phone is used in landscape, the hands can be liberated.

Specifically, as shown in FIG. 5, phone support 3 includes fixed seat 31, rotating disk 32 and ring 33. Fixed seat 31 is fixed on the back plate 1. Rotating disk 32 can be set on fixed seat 31 in a rotating way. Ring 33 is hinged to rotating disk 32. In this example, rotating disk 32 can be freely rotated in a range, ring 33 can also be freely rotated on the rotating disk 32 in a range. Therefore, the support in this example has two degrees of freedom, applicable for left side landscape or right side landscape.

In additional, when the phone is held in landscape by both hands, rotating disk 32 and ring 33 can be rotated to make ring 33 adjusted to a proper position. The middle finger or index finger can stretch into ring 33 to block out under holding status.

Of course, when the phone is held, the index finger of another hand can be positioned in the above mentioned camera hole 12, and the middle finger can be positioned to ring 33 to help positioning of thumb on the screen, forming movement memory and having fatigue resistance. The phone case has a streamlined design, combining with ring 33 and camera hole 12, more comfortable operation can be achieved during game play.

For some examples, as shown in FIG. 5, the edge of rotating disk 32 is set with part for hinge joint 321. The shape of the inner ring of ring 33 matches with the shape of rotating disk 32. Ring 33 has an open mouth. Ring 33 forms two hinged ends 331 on the two sides of the open mouth. The two hinged ends 331 are located at the two sides of the part for hinge joint 321, and the two hinged ends 331 are hinged to part for hinge joint 321. The inner ring of ring 33 matches with the shape of rotating disk 32, therefore, ring 33 can be rotated to the outer annulus of rotating disk 32 to accept ring 33.

For some examples, rotating disk 32 is a magnetic rotating disk 32; Or, there is a magnet set in the mentioned rotating disk 32; Or, the mentioned fixed seat 31 is a magnetic fixed seat 31; Or, there is a magnet set in fixed seat 31. Therefore, the phone support in this example has the function of magnet, it can be placed on the platform of ion or with magnet function, increasing the application scene of phone case.

In this example, all-round and vertical protections are provided to the four edges, four angles, obverse side and reverse side of the phone by the phone case. For profile, the length of waist and the peripheral length of the two ends are short. The phone case is streamlined overall, with thinner holding feeling. Combining with support for use, comfort is improved for use and entertainment.

The above implementation methods are only the optimized implementation methods of this utility model, they cannot be used to limit the range of this utility model protection. Any non-substantive change or replacement conducted by the technicians of this field based on this utility model is the range required to be protected by this utility model.

What is claimed is:

1. A phone case, featured by, including back plate and side panels. The mentioned side panels are set along the four edges of the back plate, and the side panels are connected in a head-to-tail manner. The mentioned back plate and side panels enclose to form an accommodating cavity to accommodate phone;
The mentioned edges of the mentioned side panels which are far from the back plate are equipped with reinforcing bars. The mentioned reinforcing bars bulge to the inside to resist to the phone frame.

2. The phone case mentioned in claim 1 is featured with the following characteristics: The cross section of the mentioned side panels is arc-shaped. There is a buffer gap between the inner lateral face of the mentioned side panel and phone frame; Or,
The cross section outline of the mentioned side panels includes the first segmental arc, the second segmental arc and the central segment between the mentioned first segmental arc and second segmental arc. There is a buffer gap between the inner lateral face of the mentioned side panels and phone frame.

3. The phone case mentioned in claim 1 is featured with the following characteristics: The inner lateral face of the mentioned back plate is set with several supports, the mentioned supports support the mentioned back plate to form a cavity with the reverse side of the phone.

4. The phone case mentioned in claim 3 is featured with the following characteristics: The mentioned side panels are equipped with tune tropes corresponding to the sounding positions of the phone. There are acoustic links between the mentioned tune tropes and the mentioned cavity. One end of the mentioned acoustic links connect to the mentioned tune trope, and other end connects to the mentioned cavity.

5. The phone case of claim 1, wherein contraction area is arranged on both sides of the back plate of the phone case.

6. The phone case mentioned in claim 5 is featured with the following characteristics: The upper end and lower end of the reverse side of the mentioned back plate are set with cambered surface or slope.

7. The phone case mentioned in claim 1 is featured with the following characteristics: The reverse side of the mentioned back plate is equipped with phone support.

8. The phone case mentioned in claim 7 is featured with the following characteristics: The mentioned phone support includes fixed seat, rotating disk and ring. The mentioned fixed seat is fixed on the mentioned back plate. The mentioned rotating disk can be set on the mentioned fixed seat in a rotating way. The mentioned ring is hinged to the mentioned rotating disk.

9. The phone case mentioned in claim 8 is featured with the following characteristics: The edge of the mentioned rotating disk is equipped with the part for hinge joint. The shape of the inner ring of the mentioned ring matches with the shape of the mentioned rotating disk. The mentioned ring has an open mouth. The mentioned ring forms two hinged ends on the two sides of the mentioned open mouth. The two mentioned hinged ends are located at the two sides of the mentioned part for hinge joint, and the two hinged ends are hinged to the mentioned part for hinge joint.

10. The phone case of claim 9, wherein said rotating disk in the middle position is the magnetic rotating disk; Or,
The mentioned rotating disk is a magnetic rotating disk; Or,
There is a magnet set in the mentioned rotating disk; Or,
The mentioned fixed seat is a magnetic fixed seat; Or,
There is a magnet set in the mentioned fixed seat.
